(19) United States
(12) Patent Application Publication
(10) Pub. No.: US 2005/0169951 A1
(43) Pub. Date: Aug. 4, 2005

(54) Pesticidal composition comprising a lactate ester as crystal growth inhibitor

(75) Inventors: Yoel Sasson, Jerusalem (IL); Ofer Toledano, Kfar Saba (IL); Ganit Levi-Ruso, Beer Sheva (IL)

Correspondence Address: BROWDY AND NEIMARK, P.L.L.C.;624 NINTH STREET, NW, SUITE 300, WASHINGTON, DC, 20001-5303, US

(73) Assignee: Makhteshim Chemical Works LTD, Omer (IL)

(21) Appl. No.: 10/507,103

(22) PCT Filed: Mar. 13, 2003
(86) PCT No.: PCT/IL03/00222

(30) Foreign Application Priority Data
Mar. 14, 2002 (IL) 148684

(51) Int. Cl. A01N 43/64; A01N 43/50; A01N 25/00; A01N 37/02

(52) U.S. Cl. 424/405; 424/195.18; 514/383; 514/397; 514/546

(57) ABSTRACT

The present invention is a method of preventing crystallization of pesticidal compositions during applications by adding a lactate ester as a crystallization preventing agent.

### FIELD OF THE INVENTION

The present invention relates to the field of pesticidal compositions, particularly to the use of lactate acid esters as a crystal growth inhibitor in said compositions.

### BACKGROUND OF THE INVENTION

Perhaps the most prevalent practice for applying pesticides to plants is by spraying a liquid composition onto the plant. Some technical difficulties are associated with this practice when predominantly aqueous compositions of pesticides which are essentially water insoluble, are employed. In such cases, often certain parts of the spraying equipment, e.g. filters and nozzles, are clogged as a result of crystal growth of the water-insoluble pesticide in said parts. A particular method for overcoming this problem is by inhibiting or preventing the crystal growth of the pesticide in the sprayer parts by employing a crystal growth inhibitor in the pesticidal composition. U.S. Pat. No. 5,206,225 describes the employment of alkylcarboxylic acid dimethylamides as crystallization inhibitors of azole fungicides. EP 637,202 describes a liquid pesticidal composition containing as crystallization inhibitor benzene which contains two or three hydroxy groups and substituted by one or more lower alkyl groups. Notwithstanding, the prior art crystallization inhibitors are organic substances which are essentially insoluble in an aqueous medium. Hence, it is necessary to employ an organic co-solvent in which the pesticide and crystal growth inhibitor are soluble. This may present difficulties in terms of environmental safety and phytotoxicity. The current practice in pest control is to reduce the use of organic solvents.

WO 00/35284 describes an aqueous suspension concentrate of triazole fungicides which contains a tristyrylphenol-ethoxylate, phosphate or sulfate thereof, with a vinylpyrolidon polymer or copolymer thereof, as a crystal growth inhibitor. However, in order to inhibit crystal growth according to WO 00/35284 it is necessary to employ a mixture of crystallization inhibitors; at least a binary mixture thereof.

Furthermore, the crystal growth inhibitors disclosed in the prior publications do not offer a solution for all needs, practices and conditions employed in agriculture. The crystal growth inhibitor may vary in accordance with the active ingredient. Thus, there is an ongoing need to develop further crystal growth inhibitors which overcome the shortcomings of the prior art.

It is therefore a purpose of the present invention to provide a pesticidal composition with a new crystal growth inhibitor.

A further purpose of the present invention is to present the new use of a compound as a crystal growth inhibitor.

Yet a further purpose of the present invention is to provide a method for crystal growth inhibition in pesticidal compositions.

Other objects of the invention will become apparent as the description proceeds.

### SUMMARY OF THE INVENTION

The present invention provides a method for preventing crystallization of pesticidal compositions during application, comprising adding a lactate ester as a crystallization prevention agent to the composition.

The present invention provides a liquid pesticidal composition comprising one or more pesticide as an active ingredient and a lactate ester as a crystal growth inhibitor.

### DETAILED DESCRIPTION OF THE INVENTION

The following description is illustrative of embodiments of the invention. The following description is not to be construed as limiting, it being understood that the skilled person may carry out many obvious variations to the invention.

Throughout the description, percentages of components are by weight, unless specifically noted differently. Furthermore, throughout the description “pesticide” refers to insecticides, herbicides, fungicides and mixtures thereof. Throughout the specification the term “azole” or “azole fungicide” also means mixtures thereof.

It has surprisingly been found that esters of lactic acid (LA) are effective as crystal growth inhibitor in liquid pesticidal compositions. Throughout the description wherein the term lactic acid, lactate esters and esters of lactic acid are used it is meant to include both optical isomers as well as mixtures thereof. Furthermore, it has surprisingly been found that mixtures of lactate esters with rosin gum, or derivatives thereof selected from among a group comprising of rosin gum, rosin esters, modified rosins, hydrogenated rosin esters, polymerized rosin esters and phenolic modified rosin esters or mixtures thereof (hereinafter “Rosin derivatives”) prevent the crystallization in the pesticidal composition.

Pesticides suitable for the practice of the present invention may be, but are not limited to azole fungicides selected from among a group comprising of epoxiconazole, tebuconazole, cyproconazole, prochloraz, penconazole, defenoconazole, flusilazole, metconazole, triadimenol, hexaconazole, flutriafol, triflumizole, fenbuconazole, bromuconazole, fluquinconazole, azaconazole, triticonazole, triadimefon and imibenconazole; strobilurin analogues, e.g. kresoxim-methyl and pyraclostrobin; maneb, mancozeb, ziram, thiram and mixtures thereof.

According to a particular aspect the present invention there is provided a method for preventing crystallization of pesticidal compositions during application, comprising adding a lactate ester or a mixture of lactate esters as a crystallization prevention agent to the composition. In the present context the term “prevention” of crystallization also encompasses “inhibition” of crystallization. The lactate ester is added to a pesticidal composition so that the lactate ester is 3% to 80% of the total composition, preferably 20% to 60%. According to yet a further embodiment, a lactate ester is added to a pesticidal composition so that the weight ratio between the pesticide and the lactate ester is from 1:0.2 to 1:5, preferably 1:1 to 1:4. Throughout the description the term lactate ester also encompasses mixtures of lactate esters.

According to yet a further embodiment a mixture of LA ester and a Rosin derivative are added as a crystallization prevention agent. The LA ester is added according to the aforementioned percentages or ratios. A Rosin derivative is added to a pesticidal composition so that the Rosin derivative is 0.5% to 20% of the total pesticidal composition, preferably 1% to 10%. According to a further embodiment a Rosin derivative may be added so that the weight ratio between the Rosin derivative and the pesticide is from 1:0.05 to 1:1, preferably 1:0.1 to 1:0.5.

According to a preferred embodiment of the present invention, the preferred lactate esters for the practice of the invention are lactate acid esters of C₄ to C₁₂ saturated and unsaturated alkyl, C₄ to C₁₂ saturated and unsaturated cyclically, C₄ to C₁₂ saturated and unsaturated branched alkyl lactates and mixtures thereof. Particularly preferable lactate esters are 2-ethyl hexyl lactate, cyclohexyl lactate, 2-methylcyclohexyl lactate, heptyl lactate, octyl lactate and mixtures thereof The preferred Rosin derivative is rosin gum.

In a particular embodiment of the invention a lactate ester is added to a pesticidal composition in order to prevent crystallization during application, wherein the pesticidal composition contains, subsequent to the addition, 3% to 80%, preferably 10% to 50% of a pesticide selected from among a group comprising of tebuconazole, epoxiconazole and prochloraz and 3% to 80%, preferably 20% to 60% lactate ester selected from among a group comprising of 2-ethyl hexyl lactate, cyclohexyl lactate, 2-methylcyclohexyl lactate, heptyl lactate, octyl lactate and mixtures thereof.

In yet a further particular embodiment of the invention a lactate ester and Rosin derivative are added to a pesticidal composition in order to prevent crystallization during application, wherein the pesticidal composition contains, subsequent to the addition, 3% to 80%, preferably 10% to 50% of a pesticide selected from among a group comprising. of tebuconazole, epoxiconazole and prochloraz 3% to 80%, preferably 20% to 60% lactate ester selected from among a group comprising of 2-ethyl hexyl lactate, cyclohexyl lactate, 2-methylcyclohexyl lactate, heptyl lactate, octyl lactate and mixtures thereof, and 0.5% to 20%, preferably 1% to 10% of a Rosin derivative selected from among a group comprising of rosin gum, rosin esters, modified rosins, hydrogenated rosin esters, polymerized rosin esters and phenolic modified rosin esters.

The present invention further provides a pesticidal composition which does not crystallize during application. Said composition comprising a pesticide or mixture of pesticides as active ingredient and a lactate ester. The composition comprising 3% to 80%, preferably 10% to 50% of a pesticide or mixture of pesticides and 3% to 80%, preferably 20% to 60% lactate ester. According to a further embodiment of the invention a pesticidal composition which does not crystallize during application comprises 3% to 80%, preferably 10% to 50% of a pesticide or mixture of pesticides, 3% to 80%, preferably 20% to 60% lactate ester and 0.5% to 20%, preferably 1% to 10% of a Rosin derivative.

According to a preferred embodiment of the invention, the present compositions comprise 10% to 50% pesticide selected from among a group comprising of tebuconazole, epoxiconazole and prochloraz, 20% to 60% of lactate ester selected from among a group comprising of 2-ethyl hexyl lactate, cyclohexyl lactate, 2-methylcyclohexyl lactate, heptyl lactate, octyl lactate and mixtures thereof, and 0.5% to 20% of a Rosin derivative selected from among a group comprising of rosin gum, and methyl ester of rosin gum.

Compositions according to the present invention may further contain surfactant agents, thickeners, anti-foaming agents, dispersing agents and wetting agents.

1% to 40% of the present composition may be surfactant agents wherein non-limiting examples of suitable surface-active compounds are nonionic, cationic and/or anionic surfactants having good emulsifying, dispersing and wetting properties. The term “surfactants” will also be understood as comprising mixtures of surfactants.

Suitable anionic surfactants can be both water-soluble soaps and water-soluble synthetic surface-active compounds. Suitable soaps are the alkali metal salts, alkaline earth metal salts or unsubstituted or substituted ammonium salts of higher fatty acids (C₁₀-C₂₂), e.g. the sodium or potassium salts of oleic or stearic acid, or of natural fatty acid mixtures which can be obtained, e.g. from coconut oil or tallow oil. Further suitable surfactants are also the fatty acid methyltaurin salts as well as modified and unmodified phospholipids.

More frequently, however, so-called synthetic surfactants are used, especially fatty sulfonates, fatty sulfates, sulfonated benzimidazole derivatives or alkylarylsulfonates.

The fatty sulfonates or sulfates are usually in the form of alkali metal salts, alkali earth metal salts or unsubstituted or substituted ammonium salts and contain a C₈-C₂₂ alkyl radical which also includes the alkyl moiety of acyl radicals, e.g. the sodium or calcium salt of lignosulfonic acid, of dodecylsulfate, or of a mixture of fatty alcohol sulfates obtained from natural fatty acids. These compounds also comprise the salts of sulfuric acid esters and sulfonic acids of fatty alcohol/ethylene oxide adducts. The sulfonated benzimidazole derivatives preferably contain 2 sulfonic acid groups and one fatty acid radical containing 8 to 22 carbon atoms. Examples of alkylarylsulfonates are the sodium, calcium or triethanolamine salts of dodecylbenzenesulfonic acid, dibutylnaphthalenesulfonic acid, or of a naphthalenesulfonic acid/formaldehyde condensation product. Also suitable are corresponding phosphates, e.g. salts of the phosphoric acid ester of an adduct of p-nonylphenol with 4 to 14 moles of ethylene oxide.

Non-ionic surfactants are preferably polyglycol ether derivatives of aliphatic or cycloaliphatic alcohols, or saturated or unsaturated fatty acids and alkylphenols, said derivatives containing 3 to 30 glycol ether groups and 8 to 20 carbon atoms in the (aliphatic) hydrocarbon moiety and 6 to 18 carbon atoms in the alkyl moiety of the alkylphenols.

Further suitable non-ionic surfactants are the water-soluble adducts of polyethylene oxide with polypropylene glycol, ethylenediaminopolypropylene glycol and alkylpolypropylene glycol containing 1 to 10 carbon atoms in the alkyl chain, which adducts contain 20 to 250 ethylene glycol ether groups and 10 to 100 propylene glycol ether groups. These compounds usually contain 1 to 5 ethylene glycol units per propylene glycol unit.

Representative examples of non-ionic surfactants are nonylphenolpolyethoxyethanols, castor oil polyglycol ethers, polypropylene/polyethylene oxide adducts, tributylphenoxypolyethoxyethanol, polyethylene glycol and octylphenoxypolyethoxyethanol. Fatty acid esters of polyoxyethylene sorbitan, e.g. polyoxyethylene sorbitan trioleate, are also suitable non-ionic surfactants.

Cationic surfactants are preferably quaternary ammonium salts which contain, as N-substituent, at least one C₈-C₂₂ alkyl radical and, as further substituents, unsubstituted or halogenated lower alkyl, benzyl or hydroxy-lower alkyl radicals. The salts are preferably in the form of halides, methylsulfates or ethylsulfates, e.g. stearyltrimethylammonium chloride or benzyldi (2-chloroethyl) ethylammonium bromide, preferably 1% to 40%.

Anti-foaming agents (AF) suitable for use in the present composition are those customarily employed in pesticidal compositions, wherein non-limiting examples of said agents are silicon oils or silicon oil emulsions in water commercially available as, e.g., Dapro DF-1161, wherein 0% to 1% of anti-foaming agent are employed, preferably 0% to 0.2%.

According to a particular aspect of the present invention, the compositions of the present invention can be either aqueous or non-aqueous compositions which contain 0% to 50% water. Non-limiting examples of such compositions are: emulsifiable concentrates (EC) and emulsion in water (EW) formulations.

### EXAMPLES

### Example 1

### Non-Crystallizing Formulation of Tebuconazole

Composition

| | | |
|---|---|---|
| tebuconazole tech. | 200 | kg. (204 kg. as 98%) |
| Berol 829¹ | 110 | kg. |
| Emcol 4500² | 50 | kg. |
| rosin Gum | 30 | kg. |
| Soft water | 15 | kg. |
| AF 100% (DF-1161)³ | 0.1 | kg. |
| Purasolve EHL(2-ethyl hexyl lactate) | up to 1000 | liters (about 580 kg.) |

¹Berol 829 - Castor oil ethoxylated 20 ethylene oxide (EO)
²Emcol 4500 - Na dioctyl sulfosuccinate
³Anti-foaming - Dapro DF-1161 produced by Daniel products company, NJ

Preparation:

Charge the Purasolve to the vessel and heat to 50-60° C. Add the tebuconazole and rosin gum and mix until homogenous solution is obtained. Cool to ambient temp. and add the Berol, Emcol and AF and mix until homogenous solution is obtained. Add the water, mix for another hour.

### Example 2

### Comparative Preparation without Crystallization Inhibitors

| | | |
|---|---|---|
| tebuconazole tech. | 200 | kg. (204 kg. as 98%) |
| Suprofor 14/R (ethoxylated castor oil) | 90 | kg. |
| Witconol NS 500 LQ | 80 | kg. |
| (EO/PO block co-polymer) | | |
| rosin Gum | 160 | kg. |
| Soft water | 25 | kg. |
| AF 100% (DF-1161) | 0.1 | kg. |
| NMP (N-Methyl Pyrrolydone) | up to 1000 | liters |

This formulation was found to crystallize during application.

### Example 3

### Formulation of Prochloraz

Composition

| | | |
|---|---|---|
| prochloraz tech. | 450 | kg. (464 kg. As 97%) |
| Rosin Gum | 30 | kg. |
| Berol 829 | 140 | kg. |
| Emcol 4500 | 60 | kg. |
| Purasolve EHL | up to 1000 | liter (about 410 kg.) |

### Example 4

### Formulation of a Mixture of Prochloraz and Tebuconazole

Composition

| | | |
|---|---|---|
| Tebuconazole tech. | 133 | kg (136 kg. as 98%) |
| Prochloraz tech. | 267 | kg (281 kg. as 95%) |
| Emulan EL⁴ | 160 | kg. |
| Emcol 4500 | 40 | kg |
| Soft water | 15 | kg. |
| AF 100% (DF-1161) | 0.1 | kg. |
| Purasolve EHL | up to 1000 | liters (about 440 kg.) |

⁴Emulan EL - Castor oil ethoxylated

Test of Crystal Growth Inhibition

The formation of crystals in spraying solutions is determined in various conditions in order to assure no crystal formation in various spraying conditions.

10 liters of spraying solutions are prepared using hard water (CIPAC standard water D, 342 ppm) in 3 different concentrations: 0.5, 1, 2 times the recommended spraying concentration for each formulation. Each sample is placed at 3 different temperatures: 2° C., 15° C. and 30° C. for 24 hours to allow crystal growth. The solutions are sprayed using a personal spraying machine and using two filters (˜8 gr. each): 100 and 50 mesh. After spraying the filters are dried and weighed. A weight difference of the filter before and after spraying of less than 0.05 gr. indicates essentially no crystal growth. Hence, there will not be filter blocking.

While embodiments of the invention have been described by way of illustration, it will be apparent that the invention may be carried out with many modifications, variations and adaptations, without departing from its spirit or exceeding the scope of the claims.

1. A method for preventing crystallization of pesticidal compositions during application, comprising adding a lactate ester as a crystallization prevention agent to the composition.

2. A method according to claim 1 wherein the lactic acid ester is selected from the group consisting of C₄ to C₁₂ saturated and unsaturated alkyl, C₄ to C₁₂ saturated and unsaturated cycloalkyl and C₄ to C₁₂ saturated and unsaturated branched alkyl lactates and mixtures thereof.

3. A method according to claim 2 wherein the lactate ester is selected from the group consisting of 2-ethyl hexyl lactate, cyclohexyl lactate, 2-methylcyclohexyl lactate, heptyl lactate, octyl lactate and mixtures thereof.

4. A method according to claim 1 wherein the lactate ester is added to a pesticidal composition so that the lactate ester is 3% to 80% of the total composition.

5. A method according to claim 4 wherein the lactate ester is added to a pesticidal composition so that the lactate ester is 20% to 60% of the total composition.

6. A method according to claim 1 wherein a lactate ester is added to a pesticidal composition so that the weight ratio between the pesticide and the lactate ester is from 1:0.1 to 1:5.

7. A method according to claim 6 wherein a lactate ester is added to a pesticidal composition so that the weight ratio between the pesticide and the lactate ester is from 1:1 to 1:4.

8. A method according to claim 1, wherein a rosin derivative is further added.

9. A method according to claim 8 wherein the rosin derivative is selected from the group consisting of rosin gum, rosin esters, modified rosins, hydrogenated rosin esters, polymerized rosin esters and phenolic modified rosin esters or mixtures thereof.

10. A method according to claim 8 wherein the Rosin derivative is added so that the Rosin derivative is 0.5% to 20% of the total pesticidal composition.

11. A method according to claim 10 wherein the Rosin derivative is added so that the Rosin derivative is 1% to 10% of the total pesticidal composition.

12. A method according to claim 8 wherein the Rosin derivative is added so that the weight ratio between the Rosin derivative and the pesticide is from 1:0.05 to 1:1.

13. A method according to claim 12 wherein the Rosin derivative is added so that the weight ratio between the Rosin derivative and the pesticide is from 1:0.1 to 1:0.5.

14. A method according to claim 1, wherein the pesticidal compositions contains as an active ingredient a pesticide selected from the group consisting of epoxiconazole, tebuconazole, cyproconazole, prochloraz, penconazole, defenoconazole, flusilazole, metconazole, triadimenol, hexaconazole, flutriafol, triflumizole, fenbuconazole, bromuconazole, fluquinconazole, azaconazole, triticonazole, triadimefon and imibenconazole; strobilurin analogues, maneb, mancozeb, ziram, thiram and mixtures thereof.

15. A liquid pesticidal composition comprising one or more pesticides as an active ingredient and a lactate ester as a crystal growth inhibitor.

16. A composition according to claim 15 wherein the lactate ester is selected from the group consisting of 2-ethyl hexyl lactate, cyclohexyl lactate, 2-methylcyclohexyl lactate, heptyl lactate, octyl lactate and mixtures thereof.

17. A composition according to claim 15 further comprising a Rosin derivative.

18. A composition according to claim 17 wherein the Rosin derivative is selected from the group consisting of rosin gum, rosin esters, modified rosins, hydrogenated rosin esters, polymerized rosin esters and phenolic modified rosin esters or mixtures thereof.

19. A composition according to claim 15, wherein the pesticide is selected from the group consisting of epoxiconazole, tebuconazole, cyproconazole, prochloraz, penconazole, defenoconazole, flusilazole, metconazole, triadimenol, hexaconazole, flutriafol, triflumizole, fenbuconazole, bromuconazole, fluquinconazole, azaconazole, triticonazole, triadimefon and imibenconazole; strobilurin analogues, maneb, mancozeb, ziram, thiram and mixtures thereof.

20. A composition according to claim 15 comprising 3% to 80% lactate ester.

21. A composition according to claim 20 comprising 1% to 10% Rosin derivative.

22. A composition according to claim 15 wherein the weight ratio between the pesticide and the lactate ester is from 1:0.1 to 1:5.

23. A composition according to claim 17 wherein the weight ratio between the pesticide and the Rosin derivative is from 1:0.05 to 1:1

24. A composition according to claim 17 comprising 1% to 10% Rosin derivative.

25. A composition according to claim 17 comprising 20% to 60% of a lactate ester selected from the group consisting of 2-ethyl hexyl lactate, cyclohexyl lactate, 2-methylcyclohexyl lactate, heptyl lactate, octyl lactate and mixtures thereof, and 1% to 10% of rosin gum.

26. (canceled)

27. (canceled)
